(19) United States
(12) Patent Application Publication
(10) Pub. No.: US 2026/0140610 A1
(43) Pub. Date: May 21, 2026

(54) INTERACTING IN SESSION

(71) Applicants: Lemon Inc., Grand Cayman (KY); Beijing Zitiao Network Technology Co., Ltd., Beijing (CN)

(72) Inventors: Lingshuang Kong, CULVER CITY, CA (US); Lingxuan Shen, Beijing (CN); Zhenan Li, Beijing (CN); Weijian Chen, Beijing (CN)

(21) Appl. No.: 19/390,442

(22) Filed: Nov. 14, 2025

(30) Foreign Application Priority Data
Nov. 15, 2024 (WO) PCT/CN2024/132504

(51) Int. Cl. G06F 3/04845; G06T 11/00; G06T 13/80; H04L 51/04; H04L 51/10

(52) U.S. Cl. CPC G06F 3/04845; G06T 11/00; G06T 13/80; H04L 51/04; H04L 51/10; G06T 2200/24

(57) ABSTRACT

According to embodiments of this disclosure, a method, apparatus, device and computer-readable storage medium for interacting in a session are provided. The method includes: sending, in response to an interaction request of a first participant in a session, an interaction message in the session, the interaction message being associated with a first image indicated by the interaction request; and presenting, in response to an interaction operation for the interaction message of a second participant in the session, in a session interface of the session, dynamic media content generated based on the first image and a second image, wherein the second image is determined based on the interaction operation. Therefore, embodiments of this disclosure can generate and provide dynamic media content by using images provided by a plurality of participants in the session, thereby improving message interaction efficiency in the session.

### CROSS-REFERENCE

This application claims priority to International Application No. PCT/CN2024/132504, filed on Nov. 15, 2024, entitled “METHOD, APPARATUS, DEVICE AND STORAGE MEDIUM FOR INTERACTING IN SESSION”, the entirety of which is incorporated herein by reference.

### FIELD

Example embodiments of the present disclosure generally relate to the field of computers, and in particular, to a method, apparatus, device, and computer-readable storage medium for interacting in a session.

### BACKGROUND

With the development of computer technologies, more and more users utilize the Internet for sessions. For example, a user may interact with other users in a session by using an instant messaging application or an instant messaging service provided by another application. The user can support message interaction of multiple modalities during the process of session interaction. For example, a user may send a text message, a voice message, or an image message in a session.

### SUMMARY

In a first aspect of the present disclosure, a method for interacting in a session is provided. The method comprises: sending, in response to an interaction request of a first participant in a session, an interaction message in the session, the interaction message being associated with a first image indicated by the interaction request; and presenting, in response to an interaction operation for the interaction message of a second participant in the session, in a session interface of the session, dynamic media content generated based on the first image and a second image, wherein the second image is determined based on the interaction operation.

In a second aspect of the present disclosure, an apparatus for interacting in a session is provided. The apparatus comprises: a sending module configured to send, in response to an interaction request of a first participant in a session, an interaction message in the session, the interaction message being associated with a first image indicated by the interaction request; and a presentation module configured to present, in response to an interaction operation for the interaction message of a second participant in the session, in a session interface of the session, dynamic media content generated based on the first image and a second image, wherein the second image is determined based on the interaction operation.

In a third aspect of the present disclosure, an electronic device is provided. The device comprises at least one processor; and at least one memory coupled to the at least one processor and storing instructions for execution by the at least one processor. The instructions, when executed by the at least one processor, cause the device to perform the method of the first aspect.

In a fourth aspect of the present disclosure, a computer-readable storage medium is provided. The computer-readable storage medium stores a computer program, and the computer program is executable by the processor to implement the method of the first aspect.

It should be understood that the content described in this summary section is not intended to limit key features or important features of the embodiments of the present disclosure, nor is it intended to limit the scope of the present disclosure. Other features of the present disclosure will become readily understood from the following description.

### BRIEF DESCRIPTION OF DRAWINGS

The above and other features, advantages, and aspects of various embodiments of the present disclosure will become more apparent from the following detailed description taken in conjunction with the accompanying drawings. In the drawings, the same or similar reference numbers refer to the same or similar elements, wherein:

FIG. 1 illustrates a schematic diagram of an example environment in which embodiments according to the present disclosure may be implemented;

FIGS. 2A-2C illustrate example interfaces according to some embodiments of the present disclosure;

FIGS. 3A-3C illustrate example interfaces according to some further embodiments of the present disclosure;

FIG. 4 illustrates a flowchart of an example process of interacting in a session according to some embodiments of the present disclosure;

FIG. 5 illustrates a schematic structural block diagram of an example apparatus for interacting in a session according to some embodiments of the present disclosure; and

FIG. 6 illustrates a block diagram of an electronic device capable of implementing various embodiments of the present disclosure.

### DETAILED DESCRIPTION

Embodiments of the present disclosure will be described in more detail below with reference to the accompanying drawings. Although some embodiments of the present disclosure are shown in the accompanying drawings, it is to be understood that the present disclosure may be implemented in various forms, and should not be interpreted as limited to embodiments set forth herein. On the contrary, these embodiments are provided for a more thorough and complete understanding of the present disclosure. It is to be understood that the drawings and embodiments of the present disclosure are merely for example purposes and are not intended to limit the scope of the present disclosure.

It should be noted that the title of any section/subsection provided herein is not limiting. Various embodiments are described throughout and any type of embodiments may be included in any section/subsection. Furthermore, the embodiments described in any section/subsection may be combined in any manner with any other embodiments described in the same section/subsection and/or different section/subsection.

In the description of embodiments of the present disclosure, the term “comprising” and the like should be understood as openness, i.e., “comprising but not limited to”. The term “based on” should be understood as “based at least in part on”. The terms “one embodiment” or “the embodiment” should be understood as “at least one embodiment”. The term “some embodiments” should be understood as “at least some embodiments”. Other explicit and implicit definitions may also be included below. The terms “first”, “second” and the like may refer to different or identical objects. Other explicit and implicit definitions may also be included below.

Embodiments of the present disclosure may relate to data of a user, obtaining and/or usage of the data, and the like. These aspects all follow the corresponding laws and regulations and related regulations. In the embodiments of the present disclosure, all data collection, obtaining, handling, processing, forwarding, usage, etc. are conducted with the user's knowledge and consent. Accordingly, when implementing the various embodiments of the present disclosure, types, usage scopes, usage scenarios, and the like of the data or information that may be involved should be informed to the users and obtain user authorization in an appropriate manner according to the relevant laws and regulations. A specific notification and/or authorization manner may vary according to actual situations and application scenarios, and the scope of the present disclosure is not limited in this respect.

The solutions in the present specification and the embodiments, if personal information processing is involved, may be processed on the premise of having a legality basis (for example, obtaining consent of a personal information subject, or being necessary for performing a contract, etc.), and may be processed only within a specified or agreed range. The user rejects personal information other than necessary information required for basic functions, and will not affect use of basic functions.

As mentioned above, text interaction and/or image interaction is a type of important interaction manner for interacting in a session. For example, in a session scenario, a participant of the session may, for example, send a text message or an image message. According to a conventional solution, a participant can only perform a limited type of interaction, for example, replying and forwarding and the like, on a message sent in the session. This affects message interaction efficiency in the session to some extent.

Embodiments of the present disclosure provide a solution for interacting in a session. The solution comprises: sending, in response to an interaction request of a first participant in a session, an interaction message in the session, the interaction message being associated with a first image indicated by the interaction request; and presenting, in response to an interaction operation for the interaction message of a second participant in the session, in a session interface of the session, dynamic media content generated based on the first image and a second image, wherein the second image is determined based on the interaction operation.

In this way, by using images provided by a plurality of participants in a session to generate and provide the dynamic media content, embodiments of the present disclosure can enrich an interaction manner in a session scenario and improve message interaction efficiency in a session, thereby improving user experience.

Various example implementations of this scheme are described in detail below in conjunction with accompanying drawings.

### Example Environment

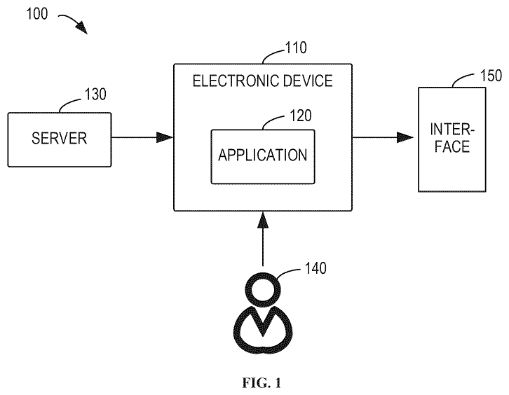

FIG. 1 illustrates a schematic diagram of an example environment 100 in which embodiments of the present disclosure may be implemented. As shown in FIG. 1, the example environment 100 may include an electronic device 110.

In this example environment 100, the electronic device 110 may run an application 120 that supports interacting in a session. The application 120 may be any suitable type of application for interacting in a session, examples of which may include, but are not limited to, an instant messaging application or other suitable applications that provide instant messaging services. A user 140 may interact with the application 120 via the electronic device 110 and/or its attachment device.

In the environment 100 of FIG. 1, if the application 120 is active, the electronic device 110 may present, through the application 120, an interface 150 for supporting interaction in the session.

In some embodiments, the electronic device 110 communicates with a server 130 to provide services to the application 120. The electronic device 110 may be any type of a mobile terminal, a fixed terminal, or a portable terminal, including a mobile phone, a desktop computer, a laptop computer, a notebook computer, a netbook computer, a tablet computer, a media computer, a multimedia tablet, a palmtop computer, a portable game terminal, a VR/AR device, a personal communication system (PCS) device, a personal navigation device, a personal digital assistant (PDA), an audio/video player, a digital camera/camcorder, a positioning device, a television receiver, a radio broadcast receiver, an electronic book device, a gaming device, or any combination of the foregoing, including accessories and peripherals of these devices, or any combination thereof. In some embodiments, the electronic device 110 may also support any type of interface for a user (such as a “wearable” circuit, etc.).

The server 130 may be an independent physical server, a server cluster composed of a plurality of physical servers, or a distributed system, or may also be a cloud server that provides basic cloud computing services such as cloud services, cloud databases, cloud computing, cloud functions, cloud storage, network services, cloud communications, middleware services, domain name services, security services, content distribution networks, and big data and artificial intelligence platforms. The server 130 may include, for example, a computing system/server, such as a mainframe, an edge computing node, a computing device in a cloud environment, or the like. The server 130 may provide background services for the application 120 in the electronic device 110 that supports interacting in the session.

A communication connection may be established between the server 130 and the electronic device 110. The communication connection may be established in a wired manner or a wireless manner. The communication connection may include, but is not limited to, a Bluetooth connection, a mobile network connection, a Universal Serial Bus (USB) connection, a Wireless Fidelity (WiFi) connection, and the like, and the embodiments of the present disclosure are not limited in this aspect. In an embodiment of the present disclosure, the server 130 and the electronic device 110 may implement signaling interaction through a communication connection between the server 130 and the electronic device 110.

It should be understood that the structures and functions of the various elements in the environment 100 are described for example purposes only and do not imply any limitation to the scope of the present disclosure.

Some example embodiments of the present disclosure will be described below with continued reference to the accompanying drawings.

### Example Interaction

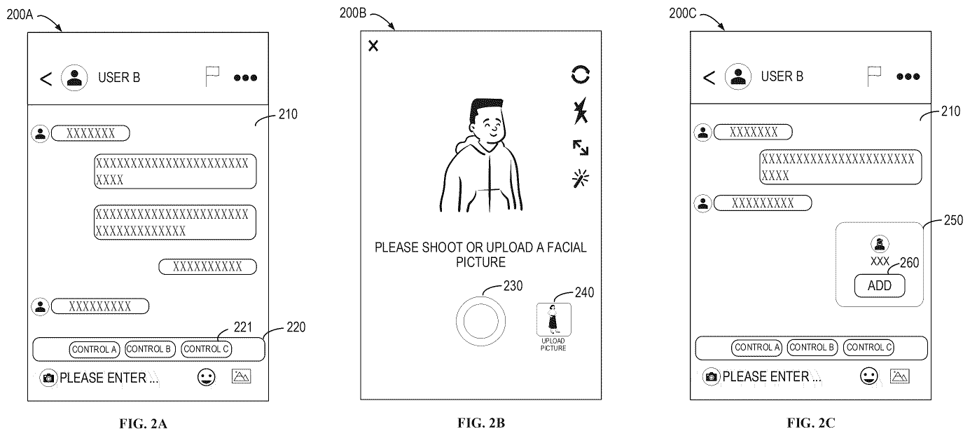

FIGS. 2A-2C illustrate example interfaces 200A-200C according to some embodiments of the present disclosure. The interfaces 200A-200C may be provided, for example, by the electronic device 110 shown in FIG. 1. As an example, the interfaces 200A-200C may correspond to a first participant (e.g., a user A) in a session.

It should be understood that a session interface shown in the following corresponds to an example session of two participants (for example, a one-to-one chat session), and the embodiments of the present disclosure may also be applied to a session scenario including a plurality of participants (for example, a group chat session).

As shown in FIG. 2A, the session interface 200A (also referred to as a first session interface) may correspond to a session of a current user (e.g., a user A) with another participant (e.g., a user B). As shown, the session interface 200A may include a message region 210 for displaying messages sent and received in a session. Additionally, the session interface 200A may also include a control region 220 that may provide one or more interaction controls, e.g., an interaction control 221, associated with the session.

In some embodiments, the electronic device 110 may receive a first operation of the user for the interaction control 221. For example, the electronic device 110 may receive a click or other appropriate action from the user for the interaction control 221. Accordingly, in response to receiving the first operation, the electronic device 110 may present an interface 200B as shown in FIG. 2B.

In some embodiments, the electronic device 110 may obtain, via the interface 200B, a first image associated with the first participant (e.g., the user A). Specifically, as shown in FIG. 2B, the interface 200B may include a capture control 230. For example, the interface 200B may present a real-time image captured by an image capturing device, and may capture the first image based on the user triggering the capture control 230.

Additionally, as shown in FIG. 2B, the interface 200B may also provide an uploading control 240. As an example, the electronic device 110 may present a set of candidate images based on a selection of the uploading control 240 of the user. Such a set of candidate images may include, for example, a local image library of the electronic device 110, or an online image library associated with the application 120. It should be understood that the obtaining and use of such candidate images is performed with user awareness and authorization.

Further, the electronic device 110 may receive a selection of at least one image of the set of candidate images by the current user (i.e., the first participant) as the first image associated with the current user.

Additionally, the electronic device 110 may further determine whether an image (for example, a captured image or an uploaded image) provided by the current user meets a predetermined requirement. Such a predetermined requirement may be related to, for example, content, quality, and/or size of the image. For example, the predetermined requirement may include that a specific type of object needs to be included in the image.

In response to obtaining the first image associated with the current user, the electronic device 110 may trigger an interaction request associated with the first image in the session. As mentioned below, referring to FIG. 2C, the interaction request may trigger generation of an interaction message corresponding to the interaction request in the session.

In some embodiments, the user A (i.e., the first participant) may also initiate the interaction request associated with the first image, for example in other manners. For example, the electronic device 110 may receive a request of the user to send image content in a session and accordingly provide one or more sending modes associated with the image content. As an example, in a first sending mode, the image content may be sent as an image message in the session, for example. In another example, in response to receiving a selection of a second sending mode, the electronic device 110 may trigger an interaction request associated with the image content to generate a corresponding interaction message instead of a normal image message.

Further, as shown in FIG. 2C, the electronic device 110 may present, in a session interface 200C, an interaction message 250 generated based on the interaction request. As shown, the interaction message 250 may, for example, present a predetermined text content to indicate a media interaction request initiated by the first participant (e.g., the user A).

Alternatively, the interaction message 250 may, for example, also present at least part of the first image indicated by the interaction request. For example, the interaction message 250 may be presented in a message card style, and the first image may be used to fill at least part of background of the message card.

Additionally, as shown in FIG. 2A, the interaction message 250 may further include a control 260. As an example, the electronic device 110 may also receive a selection of the control 260 to obtain an additional image associated with the first participant to trigger generation of corresponding dynamic media content. The specific generation process of the dynamic media content will be described in detail below.

In some embodiments, for the interaction message presented in the session interface associated with the first participant, the electronic device 110 may not provide the control 260 or disable the control 260, for example.

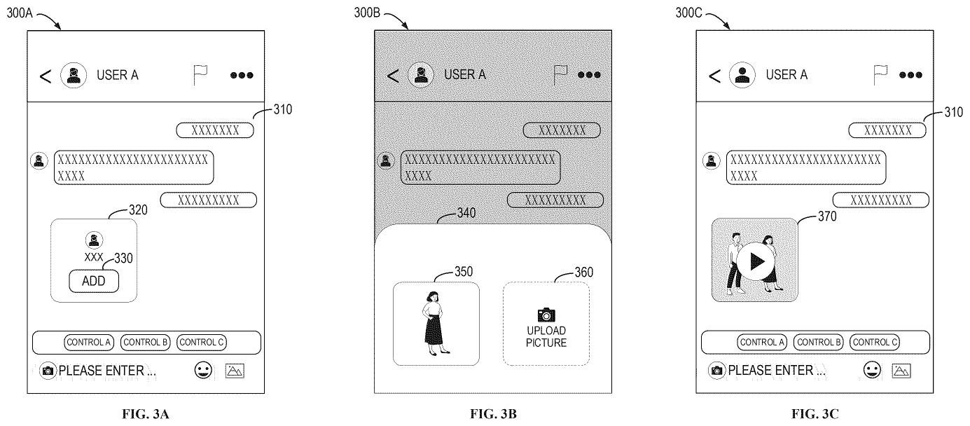

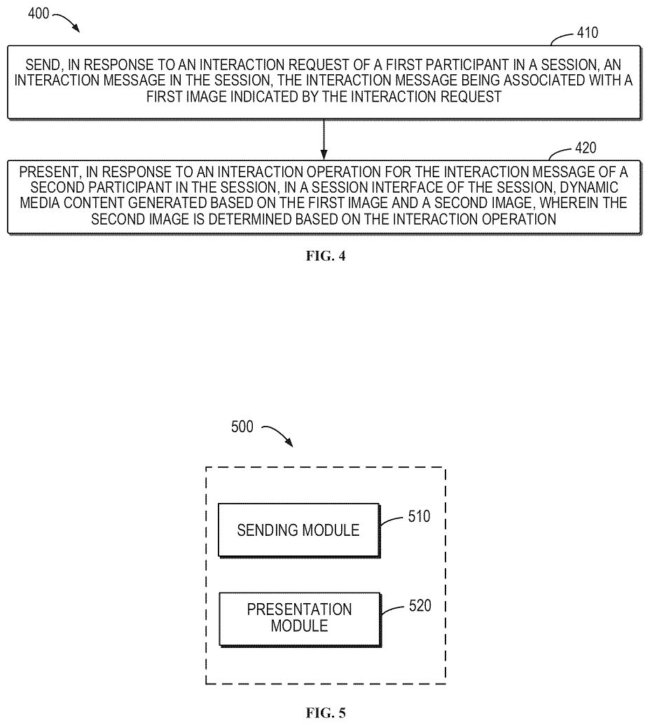

FIGS. 3A-3C illustrate example interfaces 300A-300C according to some embodiments of the present disclosure. The interfaces 300A-300C may be provided, for example, by the electronic device 110 shown in FIG. 1. As an example, the interfaces 300A-300C may correspond to a second participant (e.g., a user B) in a session.

As shown in FIG. 3A, the electronic device 110 may present an interaction message 320 in the session interface 300A. As an example, the interaction message 320 may be generated based on an interaction request (e.g., from the user A) described above with reference to FIGS. 2A-2C.

Additionally, the electronic device 110 may receive a predetermined operation of the second participant (for example, the user B) for the interaction message 320, and correspondingly present the interface 300B shown in FIG. 3B.

For example, as shown in FIG. 3A, the interaction message 320 may include a control 330. The electronic device 110 may receive a selection of the control 330 from the user to present the interface 300B. As shown in FIG. 3B, the electronic device 110 may present an interaction panel 340, which may, for example, display a first image 350 associated with the interaction message 320. As discussed above, the first image 350 may be, for example, associated with a first participant (e.g., the user A) in the session.

Additionally, as shown in FIG. 3B, the interaction panel 340 may also provide a control 360. As an example, the electronic device 110 may receive a selection of the control 360, and may correspondingly obtain a second image associated with the second participant.

As an example, the electronic device 110 may provide an interface similar to the interface 200B shown in FIG. 2B to obtain the second image associated with the second participant. For example, the second image may include an image captured by an image capturing device, or the second image may further include an image uploaded by the second participant.

In response to obtaining the second image associated with the second participant, the electronic device 110 may trigger generation of dynamic media content based on the first image and the second image. Accordingly, as shown in FIG. 2C, the electronic device 110 may display the generated dynamic media content 370 in the session interface 200C.

As such, the electronic device 110 may obtain the second image associated with the second participant based on an interaction operation of the second participant (e.g., a selection of the control 330 and image capture or uploading operation) and trigger generation of the dynamic media content based on a plurality of images associated with the participants in the session (e.g., the first image and the second image).

In some embodiments, as shown in FIG. 3C, in response to the generation of the dynamic media content 370 being completed, the electronic device 110 may present the generated dynamic media content 370 in the session interface 300C. In some embodiments, as shown in FIG. 3C, after the generation of the dynamic media content 370 is completed, the electronic device 110 may, for example, replace the interaction message 320 in the session interface 300A with the dynamic media content 370.

In some other embodiments, after the generation of the dynamic media content 370 is completed, the electronic device 110 may, for example, stop displaying the interaction message 320. Further, the electronic device 110 may present the dynamic media content 370 in the message region, and displaying location of the dynamic media content 370, for example, may be independent of the interaction message 320. For example, the interaction message 320 may be adjusted to other locations due to following message interactions received in the session. Accordingly, after the generation of the dynamic media content 370 is completed, the electronic device 110 may, for example, present the generated dynamic media content 370 below the latest message in the message region to avoid the user from missing the generated dynamic media content.

It should be understood that while FIG. 3C illustrates the session interface of the second participant, the session interface associated with the first participant (e.g., the interface 200C as shown in FIG. 2C) may also be updated similarly to present the generated dynamic media content.

Considering that the dynamic media content is generated in an asynchronous manner, after the generation of the dynamic media content 370 is completed, the electronic device 110 associated with the first participant or the second participant may also send a prompt message associated with the dynamic media content 370 to the first participant or the second participant in the session. As an example, the prompt message may include, but is not limited to, a graphic prompt message, a voice prompt message, a vibration prompt message, and the like.

For example, after the generation of the dynamic media content 370 is completed, the electronic device 110 may present a prompt message on desktop of a system regardless of whether the current user is accessing the application 120 or whether the current user is accessing the session interface of the application 120. Accordingly, the electronic device 110 may receive a selection of the prompt message of the user and may jump to presenting the session interface to present the generated dynamic media content. For example, the session interface may be automatically located to a location of the generated dynamic media content.

Additionally or alternatively, before generation of the dynamic media content 370 is completed, the electronic device 110 may also present dynamic information associated with a generation process of the dynamic media content in the session interface. As an example, the electronic device 110 may update the interaction message presented in the session interface of the first participant and the second participant to the generation progress information. As an example, the progress information may indicate a completed progress of the generation process (e.g., 50%), a remaining progress of the generation process (e.g., remaining time), and so forth. It should be understood that the progress information may be presented in any suitable form, and examples of which may include, but are not limited to, a progress bar, a percentage number, etc.

In this way, the embodiments of the present disclosure can better help the user to perceive a generation state and a generation result of the dynamic media content, thereby improving efficiency of content obtaining and interacting.

A specific generation process of the dynamic media content 370 will be further described below. In some embodiments, the dynamic media content may be generated by the electronic device 110 and/or the server 130. For ease of description, the specific generation process of the dynamic media content 370 will be described below by using the server 130 as an example.

For ease of description, a process of fusing and generating the dynamic media content 370 will be described below with two images as examples. It should be understood that such a generation process may also be applicable to fusion of images associated with more participants (e.g., three or more). Such images may include static pictures and/or dynamic video content.

In some embodiments, the server 130 may generate target background content by fusing first background content of the first image and second background content of the second image. Specifically, the server 130 may perform a segmentation process on the first image and/or the second image to correspond to foreground content and background content in the image.

Further, the server 130 may stitch the first background content and the second background content to generate intermediate background content. As an example, the server 130 may perform background alignment by using feature point matching or an image stitching algorithm. In addition, the server 130 may use a pyramid fusion technology to smoothly transition the stitched region, thereby avoiding abrupt feeling.

In addition, the server 130 may further generate the target background content by filling at least one vacant region in the intermediate background content. As an example, when there is a missing part of the stitched intermediate background content, the server 130 may complete the vacant region of the intermediate background content through an in-painting technique to ensure continuity and naturalness of the target background content. It should be understood that the server 130 may utilize any suitable technique, such as a generative model, to implement the filling of the vacant region.

Further, the server 130 may generate an intermediate image based on the target background content, first foreground content of the first image, and second foreground content of the second image. As an example, such an intermediate image may be a static image.

Additionally, the server 130 may generate the dynamic media content based on the intermediate image. For example, the server 130 may provide the intermediate image to the generative model to generate the dynamic media content, e.g., videos or dynamic pictures. As an example, such a generative model may include, for example, a picture generation video model.

In some embodiments, the generative model may also process the intermediate images based on a prompt to generate the dynamic media content. Such a prompt may include, for example, a predetermined first prompt, for example, a prompt preconfigured by the application 120.

Alternatively, the prompt may further include a second prompt determined based on at least one of input information of the first participant or input information of the second participant. As an example, the first participant or the second participant, when providing an associated image, may further provide input information for determining the prompt. Such input information may include, for example, a generation parameter for generating the dynamic media content.

For example, after uploading the image, the first participant or the second participant may specify that the style of the dynamic media content expected to be generated is a cartoon style. Alternatively, after uploading the image, the first participant or the second participant may specify that the object included in the two images performs a specific motion action, for example, hugging, shaking, and the like.

Additionally, such a generation parameter may also include other suitable parameters suitable for directing the generative model to generate the dynamic media content. For example, the first participant or the second participant may specify such a generation parameter by inputting a text prompt, selecting a predetermined tag, adjusting a parameter size, and the like.

Based on the process described above, by using images provided by a plurality of participants in the session to generate and provide the dynamic media content, embodiments of the present disclosure can enrich an interaction manner in a session scenario and improve message interaction frequency in a session, thereby improving user experience.

### Example Process

FIG. 4 illustrates a flowchart of an example process 400 of interacting in a session according to some embodiments of the present disclosure. The process 400 may be implemented at an electronic device 110. The process 400 is described below with reference to FIG. 1.

As shown in FIG. 4, in block 410, the electronic device 110 sends, in response to an interaction request of a first participant in a session, an interaction message in the session, the interaction message being associated with a first image indicated by the interaction request.

At block 420, the electronic device 110 presents, in response to an interaction operation for the interaction message of a second participant in the session, in a session interface of the session, dynamic media content generated based on the first image and a second image, wherein the second image is determined based on the interaction operation.

In some embodiments, the interaction request is triggered based on the following process: presenting a first conversation interface of the session to the first participant; receiving a first operation of the first participant for an interaction control in the first session interface; and obtaining, in response to receiving the first operation, the first image associated with the first participant to trigger the interaction request.

In some embodiments, the process 400 further includes: presenting, in response to obtaining the first image associated with the first participant, the interaction message generated based on the first image in the first session interface.

In some embodiments, the second image is determined based on the following process: presenting a second session interface of the session to the second participant; presenting the interaction message in the second session interface; and obtaining, based on a predetermined operation for the interaction message, the second image associated with the second participant.

In some embodiments, presenting, in the session interface of the session, the dynamic media content generated based on the first image and the second image includes: updating, in response to the generation of the dynamic media content being completed, the interaction message presented in the session interface to be the generated dynamic media content.

In some embodiments, presenting, in the session interface of the session, the dynamic media content generated based on the first image and the second image includes: triggering, in response to the generation of the dynamic media content being completed, sending a prompt message associated with the dynamic media content to at least one of the first participant or the second participant.

In some embodiments, the process 400 further includes: presenting, during the generation of the dynamic media content, generation progress information of the dynamic media content in the session interface.

In some embodiments, the first image and/or the second image includes picture content and/or video content.

In some embodiments, the dynamic media content is further generated based on input information obtained from at least one of the first participant or the second participant, and the input information indicates a generation parameter of the dynamic media content.

In some embodiments, the dynamic media content is generated based on the following process: generating target background content by fusing first background content of the first image and second background content of the second image; generating an intermediate image based on the target background content, first foreground content of the first image, and second foreground content of the second image; and generating the dynamic media content based on the intermediate image.

In some embodiments, generating the target background content by fusing the first background content of the first image and the second background content of the second image includes: stitching the first background content and the second background content to generate intermediate background content; and generating the target background content by filling at least one vacant region in the intermediate background content.

In some embodiments, generating the dynamic media content based on the intermediate image includes providing the intermediate image and a prompt to a media generation model to generate the dynamic media content.

In some embodiments, the prompt includes: a predetermined first prompt; or a second prompt determined based on at least one of input information of the first participant or input information of the second participant.

### Example Apparatus and Device

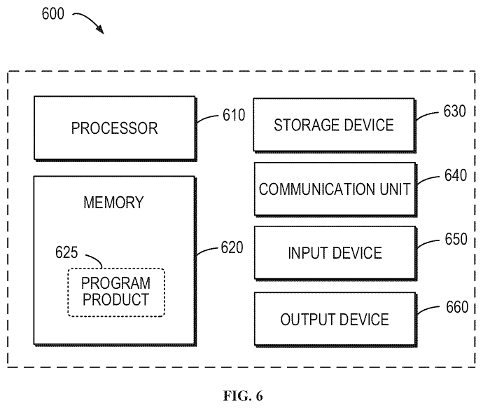

Embodiments of the present disclosure also provide a corresponding apparatus for implementing the above method or process. FIG. 5 illustrates a schematic structural block diagram of an example apparatus 500 for interacting in a session according to some embodiments of the present disclosure. The apparatus 500 may be implemented as an electronic device 110 or may be included in the electronic device 110. The various modules/components in the apparatus 500 may be implemented by hardware, software, firmware, or any combination thereof.

As shown in FIG. 5, the apparatus 500 includes: a sending module configured to send, in response to an interaction request of a first participant in a session, an interaction message in the session, the interaction message being associated with a first image indicated by the interaction request; and a presentation module configured to present, in response to an interaction operation for the interaction message of a second participant in the session, in a session interface of the session, dynamic media content generated based on the first image and a second image, wherein the second image is determined based on the interaction operation.

In some embodiments, the interaction request is triggered based on the following process: presenting a first session interface of the session to the first participant; receiving a first operation of the first participant for an interaction control in the first session interface; and obtaining, in response to receiving the first operation, the first image associated with the first participant to trigger the interaction request.

In some embodiments, the apparatus 500 further includes an interaction message generation module configured to present, in response to obtaining the first image associated with the first participant, the interaction message generated based on the first image in the first session interface.

In some embodiments, the second image is determined based on the following process: presenting a second session interface of the session to the second participant; presenting the interaction message in the second session interface; and obtaining, based on a predetermined operation for the interaction message, the second image associated with the second participant.

In some embodiments, presenting, in the session interface of the session, the dynamic media content generated based on the first image and the second image includes: updating, in response to the generation of the dynamic media content being completed, the interaction message presented in the session interface to be the generated dynamic media content.

In some embodiments, presenting, in the session interface of the session, the dynamic media content generated based on the first image and the second image includes: triggering, in response to the generation of the dynamic media content being completed, sending a prompt message associated with the dynamic media content to at least one of the first participant or the second participant.

In some embodiments, the apparatus 500 further includes a generation progress information module configured to present, during the generation of the dynamic media content, generation progress information of the dynamic media content in the session interface.

In some embodiments, the first image and/or the second image includes picture content and/or video content.

In some embodiments, the dynamic media content is further generated based on input information obtained from at least one of the first participant or the second participant, prompting a generation parameter of the dynamic media content.

In some embodiments, the dynamic media content is generated based on the following process: generating target background content by fusing first background content of the first image and second background content of the second image; generating an intermediate image based on the target background content, first foreground content of the first image, and second foreground content of the second image; and generating the dynamic media content based on the intermediate image.

In some embodiments, generating the target background content by fusing the first background content of the first image and the second background content of the second image includes: stitching the first background content and the second background content to generate intermediate background content; and generating the target background content by filling at least one vacant region in the intermediate background content.

In some embodiments, generating the dynamic media content based on the intermediate image includes providing the intermediate image and a prompt to a media generation model to generate the dynamic media content.

In some embodiments, the prompt word includes: a predetermined first prompt; or a second prompt determined based on at least one of input information of the first participant or input information of the second participant.

As shown in FIG. 6, an electronic device 600 is in a form of a general-purpose electronic device. Components of the electronic device 600 may include, but are not limited to, one or more processors or processing units 610, memories 620, storage devices 630, one or more communication units 640, one or more input devices 650, and one or more output devices 660. The processor 610 may be an actual or virtual processor and capable of performing various processes according to programs stored in the memory 620. In a multiprocessor system, a plurality of processors perform computer-executable instructions in parallel to improve parallel processing capabilities of the electronic device 600.

Electronic device 600 typically includes a plurality of computer storage media. Such media may be any available media accessible to the electronic device 600, including, but not limited to, volatile and non-volatile media, removable and non-removable media. The memory 620 may be a volatile memory (e.g., a register, a cache, a random access memory (RAM)), a non-volatile memory (e.g., a read-only memory (ROM), an electrically erasable programmable read-only memory (EEPROM), a flash memory), or some combination thereof. Storage device 630 may be a removable or non-removable medium and may include a machine-readable medium, such as a flash drive, magnetic disk, or any other medium, which may be capable of storing information and/or data and may be accessed within the electronic device 600.

The electronic device 600 may further include additional removable/non-removable, volatile/non-volatile storage media. Although not shown in FIG. 6, a disk drive for reading or writing from a removable, non-volatile magnetic disk (e.g., a “floppy disk”) and an optical disk drive for reading or writing from a removable, non-volatile optical disk may be provided. In these cases, each drive may be connected to a bus (not shown) by one or more data media interfaces. The memory 620 may include a computer program product 625 having one or more program modules configured to perform various methods or acts of various embodiments of the present disclosure.

The communication unit 640 is configured to communicate with other electronic devices through a communication medium. Additionally, the functionality of components of the electronic device 600 may be implemented in a single computing cluster or a plurality of computing machines capable of communicating over a communication connection. Thus, the electronic device 600 may operate in a networked environment using logical connections with one or more other servers, network personal computers (PCs), or another network node.

The input device 650 may be one or more input devices such as a mouse, a keyboard, a trackball, or the like. The output device 660 may be one or more output devices, such as a display, a speaker, a printer, or the like. The electronic device 600 may also communicate with one or more external devices (not shown) through the communication unit 640 as needed, the external devices such as storage devices, display devices, etc., communicate with one or more devices that enable a user to interact with the electronic device 600, or communicate with any device (e.g., a network card, a modem, etc.) that enables the electronic device 600 to communicate with one or more other electronic devices. Such communication may be performed via an input/output (I/O) interface (not shown).

According to example implementations of the present disclosure, a computer-readable storage medium having computer executable instructions stored thereon is provided, where the computer executable instructions are executed by a processor to implement the method described above. According to example implementations of the present disclosure, a computer program product is further provided, the computer program product being tangibly stored on a non-transitory computer-readable medium and including computer executable instructions, the computer-executable instructions being executed by a processor to implement the method described above.

Aspects of the present disclosure are described herein with reference to flowcharts and/or block diagrams of methods, apparatuses, devices, and computer program products implemented in accordance with the present disclosure. It should be understood that each block of the flowcharts and/or block diagrams, and combinations of blocks in the flowcharts and/or block diagrams, may be implemented by computer-readable program instructions.

These computer-readable program instructions may be provided to a processor of a general purpose computer, special purpose computer, or other programmable data processing apparatus to produce a machine, such that the instructions, when executed by a processor of a computer or other programmable data processing apparatus, produce apparatuses to implement the functions/acts specified in the flowcharts and/or block diagrams. These computer-readable program instructions may also be stored in a computer-readable storage medium that cause the computer, programmable data processing apparatus, and/or other devices to function in a particular manner, such that the computer-readable medium storing instructions includes an article of manufacture including instructions to implement aspects of the functions/acts specified in the flowcharts and/or block diagrams.

The computer-readable program instructions may be loaded onto a computer, other programmable data processing apparatuses, or other devices, such that a series of operational steps are performed on a computer, other programmable data processing apparatuses, or other devices to produce a computer-implemented process, thereby enabling the instructions executed on a computer, other programmable data processing apparatuses, or other devices to implement the functions/acts specified in the flowcharts and/or block diagrams block or blocks.

The flowcharts and block diagrams in the drawings show architecture, functionality, and operation of possible implementations of systems, methods, and computer program products according to various implementations of the present disclosure. In this regard, each block in the flowcharts or block diagrams may represent a module, program segment, or portion of an instruction that includes one or more executable instructions for implementing the specified logical function. In some alternative implementations, the functions noted in the blocks may also occur in a different order than noted in the figures. For example, two consecutive blocks may actually be performed substantially in parallel, which may sometimes be performed in a reverse order, depending on the functionality involved. It is also noted that each block in the block diagrams and/or flowcharts, as well as combinations of blocks in the block diagrams and/or flowcharts, may be implemented with a dedicated hardware-based system that performs the specified functions or acts, or may be implemented in a combination of dedicated hardware and computer instructions.

Various implementations of the present disclosure have been described above, and the above descriptions are, for example, not exhaustive, and are not limited to the implementations disclosed. Many modifications and variations without departing from the scope and spirit of the various implementations illustrated will be apparent to those of ordinary skill in the art. Selection of the terms used herein is intended to best explain the principles of the implementations, practical applications, or improvements to techniques in the marketplace, or to enable others of ordinary skill in the art to understand the various implementations disclosed herein.

1. A method for interacting in a session, comprising:
sending, in response to an interaction request of a first participant in a session, an interaction message in the session, the interaction message being associated with a first image indicated by the interaction request; and
presenting, in response to an interaction operation for the interaction message of a second participant in the session, in a session interface of the session, dynamic media content generated based on the first image and a second image, wherein the second image is determined based on the interaction operation.

2. The method of claim 1, wherein the interaction request is triggered based on the following process:
presenting a first session interface of the session to the first participant;
receiving a first operation of the first participant for an interaction control in the first session interface; and
obtaining, in response to receiving the first operation, the first image associated with the first participant to trigger the interaction request.

3. The method of claim 2, further comprising:
presenting, in response to obtaining the first image associated with the first participant, the interaction message generated based on the first image in the first session interface.

4. The method of claim 1, wherein the second image is determined based on the following process:
presenting a second session interface of the session to the second participant;
presenting the interaction message in the second session interface; and
obtaining, based on a predetermined operation for the interaction message, the second image associated with the second participant.

5. The method of claim 1, wherein presenting, in the session interface of the session, the dynamic media content generated based on the first image and the second image comprises:
updating, in response to the generation of the dynamic media content being completed, the interaction message presented in the session interface to be the generated dynamic media content.

6. The method of claim 5, wherein presenting, in the session interface of the session, the dynamic media content generated based on the first image and the second image comprises:
triggering, in response to the generation of the dynamic media content being completed, sending a prompt message associated with the dynamic media content to at least one of the first participant or the second participant.

7. The method of claim 1, further comprising:
presenting, during the generation of the dynamic media content, generation progress information of the dynamic media content in the session interface.

8. The method of claim 1, wherein the dynamic media content is further generated based on input information obtained from at least one of the first participant or the second participant, and the input information indicates a generation parameter of the dynamic media content.

9. The method of claim 1, wherein the dynamic media content is generated based on the following process:
generating target background content by fusing first background content of the first image and second background content of the second image;
generating an intermediate image based on the target background content, first foreground content of the first image, and second foreground content of the second image; and
generating the dynamic media content based on the intermediate image.

10. The method of claim 9, wherein generating the target background content by fusing the first background content of the first image and the second background content of the second image comprises:
stitching the first background content and the second background content to generate intermediate background content; and
generating the target background content by filling at least one vacant region in the intermediate background content.

11. The method of claim 9, wherein generating the dynamic media content based on the intermediate image comprises:
providing the intermediate image and a prompt to a media generation model to generate the dynamic media content.

12. The method of claim 11, wherein the prompt comprises:
a predetermined first prompt; or
a second prompt determined based on at least one of input information of the first participant or input information of the second participant.

13. An electronic device, comprising:
at least one processor; and
at least one memory coupled to the at least one processor and storing instructions for execution by the at least one processor, wherein the instructions, when executed by the at least one processor, causing the electronic device to perform acts comprising:
sending, in response to an interaction request of a first participant in a session, an interaction message in the session, the interaction message being associated with a first image indicated by the interaction request; and
presenting, in response to an interaction operation for the interaction message of a second participant in the session, in a session interface of the session, dynamic media content generated based on the first image and a second image, wherein the second image is determined based on the interaction operation.

14. A non-transitory computer-readable storage medium having a computer program stored thereon, the computer program being executable by a processor to implement acts comprising:
sending, in response to an interaction request of a first participant in a session, an interaction message in the session, the interaction message being associated with a first image indicated by the interaction request; and
presenting, in response to an interaction operation for the interaction message of a second participant in the session, in a session interface of the session, dynamic media content generated based on the first image and a second image, wherein the second image is determined based on the interaction operation.

15. The electronic device of claim 13, wherein the interaction request is triggered based on the following process:
presenting a first session interface of the session to the first participant;
receiving a first operation of the first participant for an interaction control in the first session interface; and
obtaining, in response to receiving the first operation, the first image associated with the first participant to trigger the interaction request.

16. The electronic device of claim 13, wherein the acts further comprises:
presenting, in response to obtaining the first image associated with the first participant, the interaction message generated based on the first image in the first session interface.

17. The electronic device of claim 13, wherein the second image is determined based on the following process:
presenting a second session interface of the session to the second participant;
presenting the interaction message in the second session interface; and
obtaining, based on a predetermined operation for the interaction message, the second image associated with the second participant.

18. The electronic device of claim 13, wherein presenting, in the session interface of the session, the dynamic media content generated based on the first image and the second image comprises:
updating, in response to the generation of the dynamic media content being completed, the interaction message presented in the session interface to be the generated dynamic media content.

19. The electronic device of claim 13, wherein presenting, in the session interface of the session, the dynamic media content generated based on the first image and the second image comprises:
triggering, in response to the generation of the dynamic media content being completed, sending a prompt message associated with the dynamic media content to at least one of the first participant or the second participant.

20. The electronic device of claim 13, wherein the acts further comprises:
presenting, during the generation of the dynamic media content, generation progress information of the dynamic media content in the session interface.
